(19) United States
(12) Patent Application Publication
(10) Pub. No.: US 2012/0166554 A1
(43) Pub. Date: Jun. 28, 2012

(54) AUTOMATICALLY COMPRESSING E-MAIL FORWARDED TO A USER TELEPHONE

(75) Inventor: Scott E. PREECE, Champaign, IL (US)

(73) Assignee: Yahoo! Inc, Sunnyvale, CA (US)

(21) Appl. No.: 12/978,652

(22) Filed: Dec. 27, 2010

(51) Int. Cl. G06F 15/16

(52) U.S. Cl. 709/206

(57) ABSTRACT

A method receiving an e-mail message addressed to a recipient and comprising header data and message content. The method applies a template to transform the e-mail message to an SMS (Short Message Service) format. The method also forwards the message to the recipient as a first SMS message.

### BACKGROUND

1. Technical Field

Embodiments of the invention relate generally to e-mail applications, and more specifically, to compressing an e-mail for forwarding as an SMS (Short Message Service) message.

2. Prior Art

Many people need to access e-mail messages when away from a desktop computer. For example, when traveling to a destination, an e-mail may be sent with an updated location. Smart telephones, laptops and other devices are able to receive e-mails while traveling. However, smart telephones can be very expensive and require additional charges for data services. Some smart telephones are just too complex. On the other hand, a laptop computer, although mobile, is very bulky. Additionally, it needs a power source or sufficient battery charge, and also needs a service to connect to the Internet.

In the light of the foregoing discussion, there is a need for accessing e-mails over an SMS (Short Messaging Service) service.

### SUMMARY

The above-mentioned needs are met by a method, computer program product and system for forwarding compressed e-mail content using, for example, SMS (Short Messaging Service).

In one embodiment, a method receiving an e-mail message addressed to a recipient and comprising header data and message content. The method applies a template to transform the e-mail message to an SMS (Short Message Service) format. The method also forwards the message to the recipient as a first SMS message.

In another embodiment, a system includes an interface to receive an e-mail message addressed to a receiver and comprising header data and message content. A converter unit, communicatively coupled to the interface, to apply a template to transform the e-mail message to an SMS (Short Message Service) format. The interface forwards the message to the receiver as a first SMS message.

Advantageously, a user can easily access e-mails, even from a simple cell phone.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a flow chart illustrating a method for forwarding compressed e-mail messages over SMS according to an embodiment.

FIG. 2 is a flow chart illustrating a method for applying a template to transform an e-mail message to an SMS format according to an embodiment.

FIG. 3 is a flow chart illustrating a method for creating a template from an e-mail according to an embodiment.

FIG. 4 is a schematic diagram illustrating template generation according to an embodiment.

FIG. 5 is a block diagram illustrating a system to forward compressed e-mails over SMS according to an embodiment.

FIG. 6 is a block diagram illustrating a computing device of the system in accordance to an embodiment.

FIG. 7 is a block diagram of an e-mail server of the system according to an embodiment.

FIG. 8 is a block diagram of a compression module of the e-mail server according to an embodiment.

### DETAILED DESCRIPTION

The above-mentioned needs are met by a method, computer program product and system for forwarding an e-mail message as an SMS (Short Message Service) message. The following detailed description is intended to provide example implementations to one of ordinary skill in the art, and is not intended to limit the invention to the explicit disclosure, as one or ordinary skill in the art will understand that variations can be substituted that are within the scope of the invention as described.

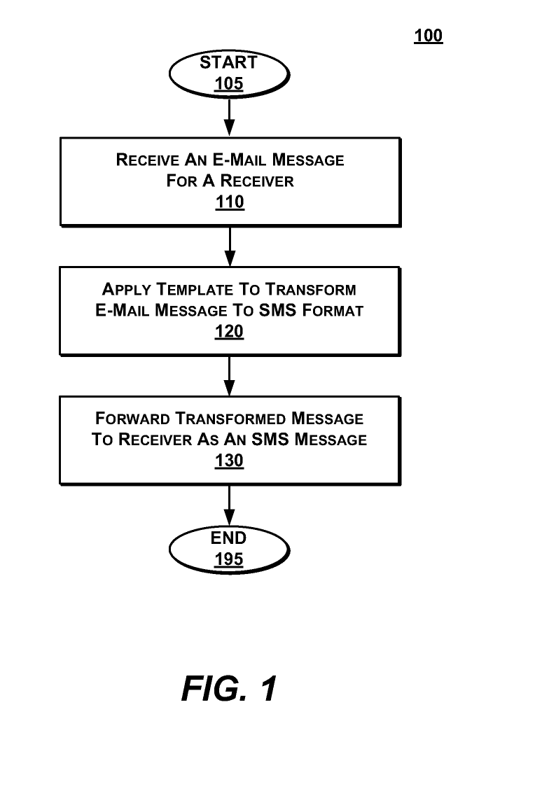

FIG. 1 is a flow chart illustrating a method 100 for forwarding compressed e-mail messages over SMS according to an embodiment. The output format is discussed as an SMS message herein for the purpose of simplicity. One of ordinary skill in the art will recognize that, given the present disclosure, other message formats can be used such as MMS (Multi-Media Message Service). The SMS format is preferred because SMS clients are widely available on mobile phones, in particular, older models that do not have data service or state-of-the art processing and software.

At step 110, an e-mail message is received. The e-mail can be received at a web-based e-mail service (e.g., Yahoo! Mail, HotMail or Gmail) or at a local application (Microsoft Outlook). The email includes a header and a body. The email header includes various fields, for example, a “To” field, a “From” field and a “Subject” field. The “To” field includes control information, for example, an address of a recipient. The “From” field also includes control information, in one example, an address of the sender. One or more recipients can be added to the email header. The one or more recipients can be added to a “carbon copy (dc)” field and a “blind carbon copy (bcc)” field. The email header further includes a “Date” field. The “Date” field indicates the date and time the email has been transmitted or received. The email body includes content information. Examples of content information include, but are not limited to, text, images, audio video and any other information provided by a sender. Various metadata is also included in e-mail such as routing stamps added as an e-mail travels across the Internet.

Various protocols are employed for transferring e-mail from the sender to the recipient. Examples of protocols include, but are not limited to, simple mail transfer protocol (SMTP), file transfer protocol (FTP), hyper text transfer protocol (HTTP), post office protocol (POP), internet message access protocol (IMAP) and multipurpose internet mail extension (MIME).

At step 120, a template is applied to transform the e-mail to SMS format. In one embodiment, the template extracts essential information from the e-mail message using rules. In one implementation, the template includes default transformations common to e-mails. In another implementation, the template includes custom transformations that are particular to a sender.

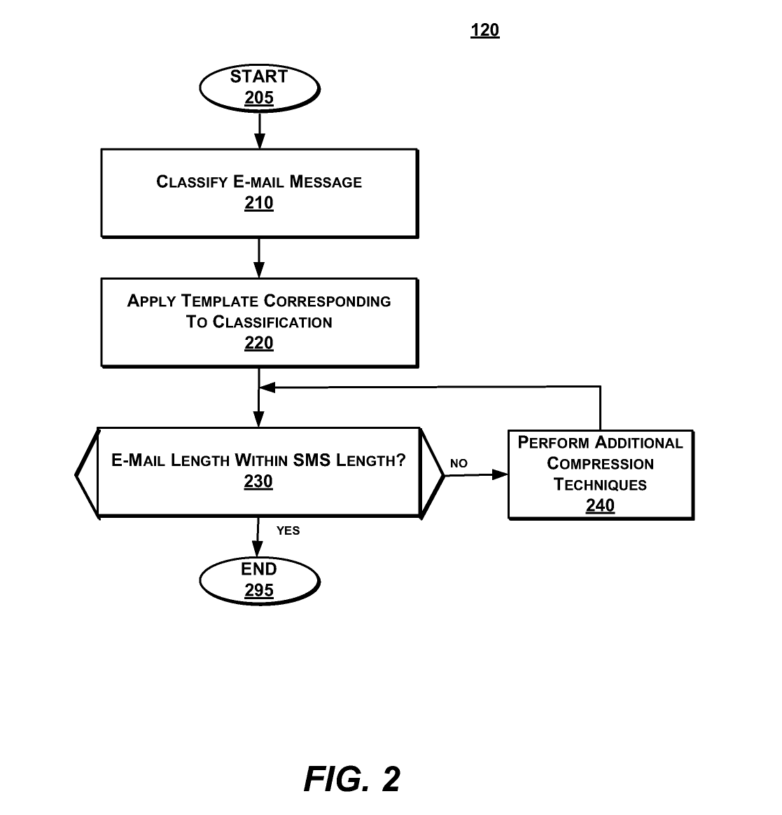

In another embodiment, one or more templates are continuously applied until the e-mail message has been reduced to a single SMS message of, for example, 1690 characters. Additional embodiments of step 120 are discussed below with respect to FIG. 2.

At step 130, a transformed message is forwarded to as an SMS message. In one embodiment, a recipient's name is matched to a mobile telephone number. The SMS message is then sent over a data network to reach an SMS network which can connect to a recipient over a cellular network. Of course, in other embodiments, the SMS message can be sent over a data network to an SMS client such as an instant messenger.

FIG. 2 is a flow chart illustrating a method 120 for applying a template to transform an e-mail message to an SMS format according to an embodiment.

At step 210, an e-mail message is classified. Each classification has one or more associated templates for compression. In one embodiment, classification is determined merely by a sender. Some senders send e-mails that follow a consistent format. For example, a bank can send a daily e-mail with an account balance. The only variable part of the e-mail is the balance itself. In another embodiment, classification can be determined from pattern recognition. For example, a structure of the e-mail can be defined by anchors, as described more fully below. In some implementations, a catch-all classification can be defined and associated with a default template. The default template has compressions that can be applied to substantially all e-mail messages.

At step 220, a template corresponding to a classification is applied. A template can be defined by a set of rules. A rule can be defined by attributes of an e-mail such as HTML headers, keywords or phrases, values, fields, and the like. A general aim of a template is to eliminate information from an e-mail message that is not useful to a recipient, and to extract information that is useful.

A default template can apply rules that are common for a substantial amount of e-mail messages. For example, routing information can be automatically removed. Also, addressee information such as list of other recipients, although it has some relevance, can be eliminated when restricted to the length of an SMS message. Another compression technique abbreviates words and phrases to well known abbreviations. For example, Los Angeles to LA, for your information to FYI, see to C, you to U, and so on. Another rule can abbreviate words by removing some vowels, for example, anthr rle cn abbrvte wrds by rmving sm yowls.

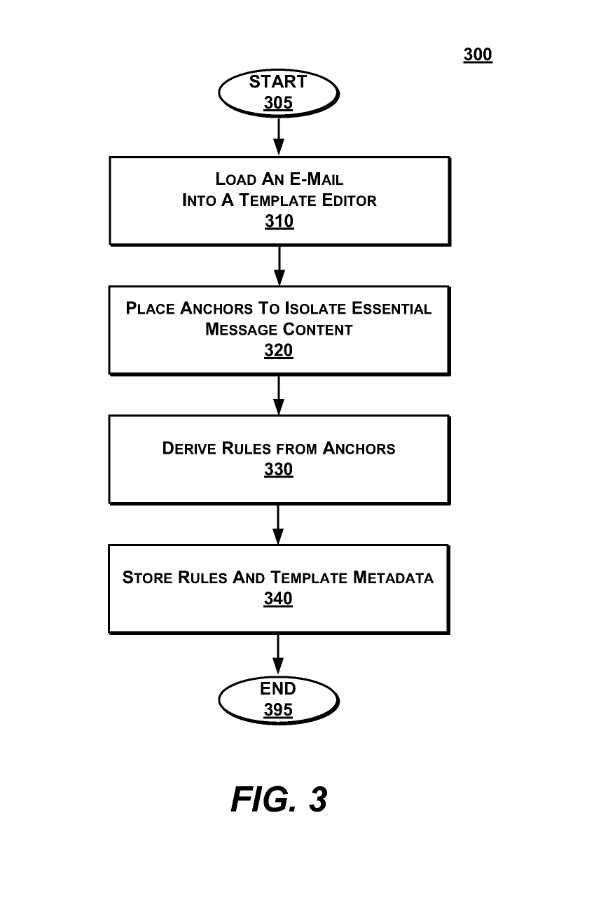

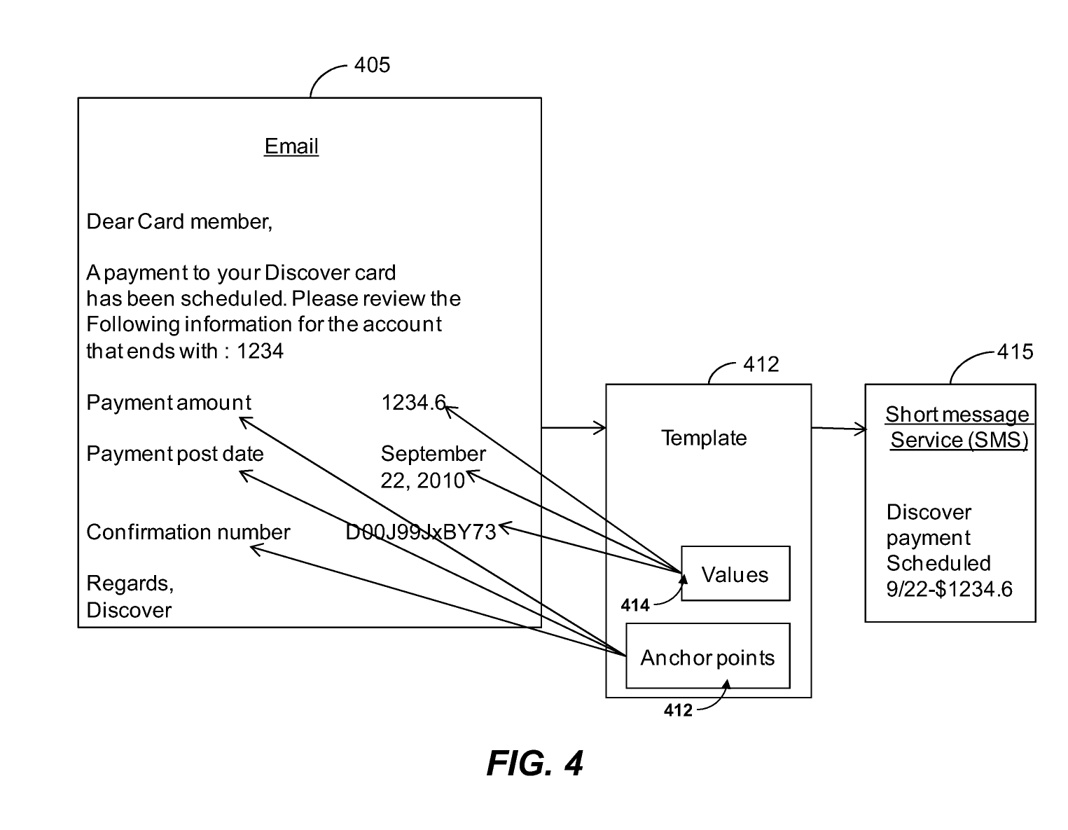

A custom template can apply rules as configured by a recipient. For example, a custom dictionary can be maintained to accumulate user-defined abbreviations. A custom template can also be generated by a user from an e-mail in a template editor as described below with respect to FIGS. 3 and 4.

At step 230, if an e-mail is not within SMS length, at step 240, additional compression techniques are performed. In one embodiment, templates can be applied in a preferred order until an acceptable length is achieved. For short e-mail messages, simply removing metadata may be enough. For longer e-mail messages, all templates may have to be applied. Even then, a message that is above the maximum length may have to be cut off at a certain point. In this case, a recipient has preview of an e-mail and can request, via return SMS, that additional SMS messages provide more text of the e-mail. A recipient may also wish to undo some compression techniques and have a pure preview sent.

FIG. 3 is a flow chart illustrating a method 300 for creating a template from an e-mail according to an embodiment.

At step 310, an e-mail is loaded into a template editor. When a recipient receives an e-mail that is a good candidate for a template, the template editor can generate custom rules to be applied to future e-mails. Certain senders, in particular from automatically generated e-mails, send e-mails with similar formatting. For example, when making an online purchase from Amazon, a transaction confirmation is automatically sent. Additionally, a shipping update is sent once a seller sends off a product that is purchased.

At step 320, anchors can be placed to isolate essential message content. The template editor can include various tools including anchors as shown in FIG. 4. Anchor points 412 identify variable data in a repeated message format. The anchor points identify payment amount, payments post date and confirmation number. In subsequent e-mail messages, a template looks for these codes. Values 414 are the variable information associated with anchor points 412. In the example of FIG. 4, e-mail message 405 is reduced to SMS message 415 using template 412.

At step 330, rules are derived from anchors. The GUI-based anchor points are translated to a set of rules that may or may not be accessible by users. When anchors are updated in a template editor, associated rules are updated as well.

At step 340, rules and template metadata are stored. The template metadata can include identification information for recalling a template. Other template metadata can be information used to classify e-mails that can be compressed by the template.

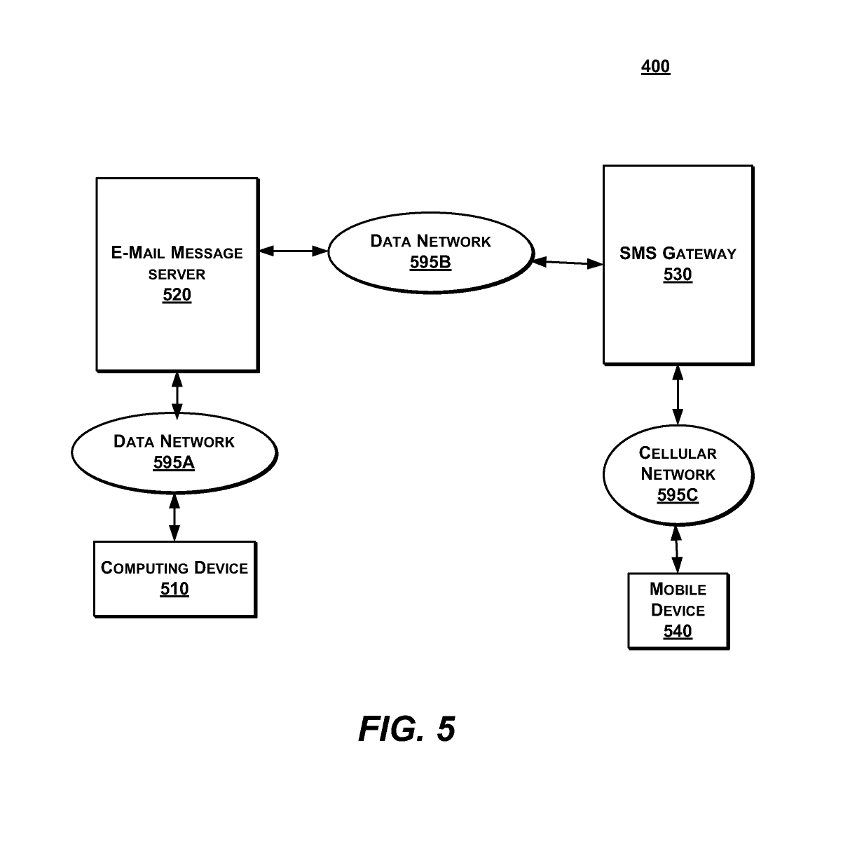

FIG. 5 is a block diagram illustrating a system 500 to forward compressed e-mails over SMS according to an embodiment. The system 500 can implement methods discussed above. The system 500 includes a computing device 510, a e-mail server 520, and an SMS gateway 530 coupled in communication through networks 595A-C (e.g., the Internet or a cellular network).

The computing device 510 can be, for example, a PC, a stationary computing device, a laptop or notebook computer, a tablet computer, a smart phone or PDA, a smart appliance, a video gaming console, an Internet television, a set-top box, or any other suitable processor-based device that can send view advertisements. There can be numerous computing devices 510 used by different users. In one embodiment, the computing device 510 allows a user to send and receive e-mail messages. Furthermore, a recipient can configure templates and forwarding information using computing device 510. Additional embodiments of the computing device 510 are described in more detail below.

The e-mail server 520 can be one or more of any of the above processor-based devices. In one embodiment, the e-mail server 520 receives e-mail messages for a recipient and forwards a compressed version as an SMS message. Additional embodiments of the e-mail server 520 are described in more detail below.

The SMS gateway 530 can be one or more of any of the above processing-based devices. In one embodiment, the SMS gateway 530 forwards SMS messages to a mobile device 540 of the recipient.

The mobile device 540 can be a mobile telephone with an SMS client. In other embodiments, the mobile device 540 can be any of the processor-based devices described in association with the computing device 510. In one embodiment, a mobile device 540 receives SMS messages that represent e-mail messages.

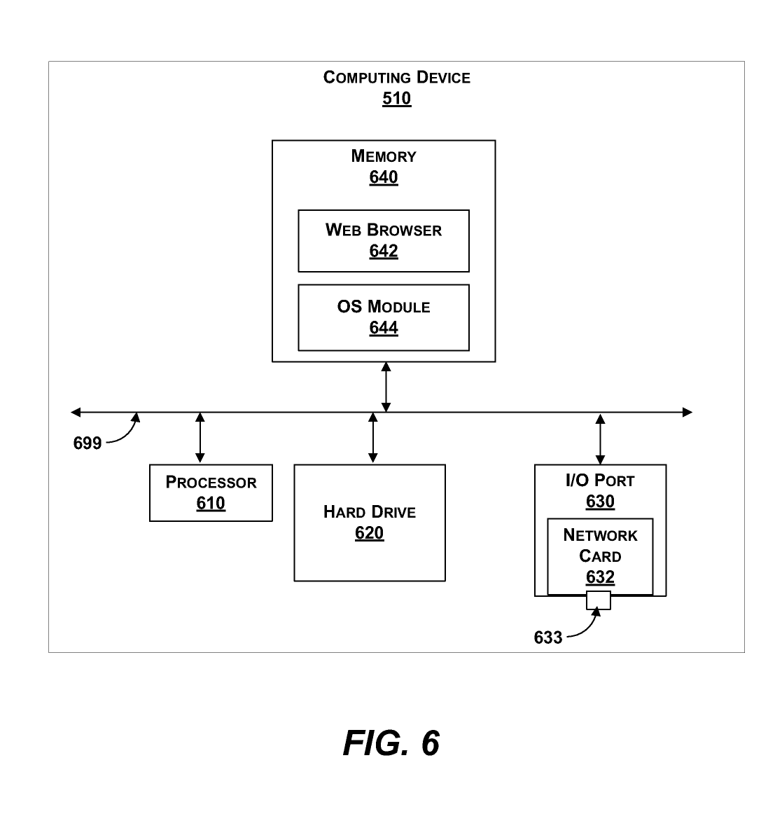

FIG. 6 is a block diagram illustrating a computing device 510 of the system 500 in accordance to an embodiment. The computing device 510 includes a processor 610, a hard drive 620, an I/O port 630, and a memory 640 coupled by a bus 699.

The bus 699 can be soldered to one or more motherboards. The processor 610 can be a general purpose processor, an application-specific integrated circuit (ASIC), an FPGA (Field Programmable Gate Array), a RISC (Reduced Instruction Set Controller) processor, an integrated circuit, or the like. There can be a single core, multiple cores, or more than one processor. In one embodiment, the processor 610 is specially suited for the processing demands of e-mail messaging (e.g., custom micro-code, instruction fetching, pipelining or cache sizes).

The processor 610 can be disposed on silicon or any other suitable material. In operation, the processor 610 can receive and execute instructions and data stored in the memory 640 or the hard drive 620. The hard drive 620 can be a platter-based storage device, a flash drive, an external drive, a persistent memory device, or any other type of memory.

The hard drive 620 provides persistent (i.e., long term) storage for instructions and data. The I/O port 620 is an input/output panel including a network card 622. The network card 622 can be, for example, a wired networking card (e.g., a USB card, or an IEEE 802.3 card), a wireless networking card (e.g., an IEEE 802.11 card, or a Bluetooth card), a cellular networking card (e.g., a 3G card). An interface 623 is configured according to networking compatibility. For example, a wired networking card includes a physical port to plug in a cord, and a wireless networking card includes an antennae. The network card 622 provides access to a communication channel on a network.

The memory 640 can be a RAM (Random Access Memory), a flash memory, a non-persistent memory device, or any other device capable of storing program instructions being executed. The memory 640 further comprises a web browser 642, and an OS (operating system) module 644. The OS module 644 can be one of the Microsoft Windows® family of operating systems (e.g., Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, or IRIX64.

The web browser 642 can be a desktop web browser (e.g., Internet Explorer, Mozilla, or Chrome), a mobile browser, or a web viewer integrated into an application program. In an embodiment, a user accesses a system on the World Wide Web (WWW) through a network such as the Internet. The web browser 642 is used to download web pages or other content in various formats including HTML, XML, text, PDF, and postscript, and may be used to upload information to other parts of the system. The web browser 642 may use URLs to identify resources on the web and HTTP (HyperText Transfer Protocol) in transferring files on the web. In one embodiment, the web browser 642 allows a user to manage financial portfolios and social networking.

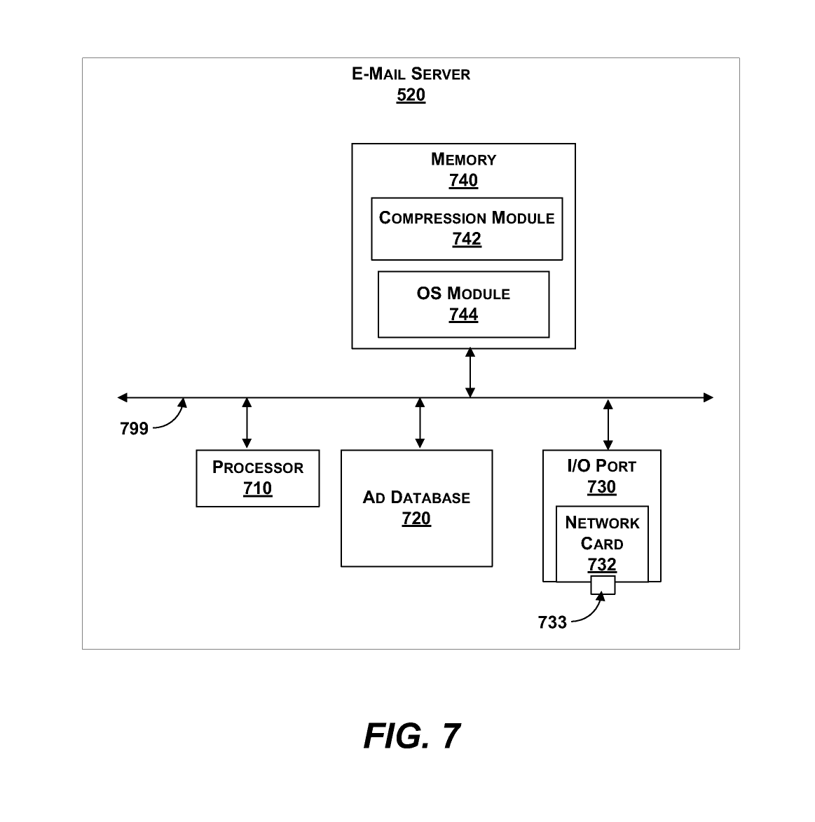

FIG. 7 is a block diagram of an e-mail server 520 of the system 500 according to an embodiment. The e-mail server 520 includes a processor 710, an advertisement database 720, an I/O port 730, and a memory 740, coupled by a bus 799. The processor 710, a hard drive 720, and the I/O port 730 can be configured as described above with respect to FIG. 6.

The memory 740 comprises an OS module 744, as described above, along with a compression module 742. In one embodiment, the compression module 742 transforms e-mail messages to an SMS message. The compression module 742 is described in more detail below.

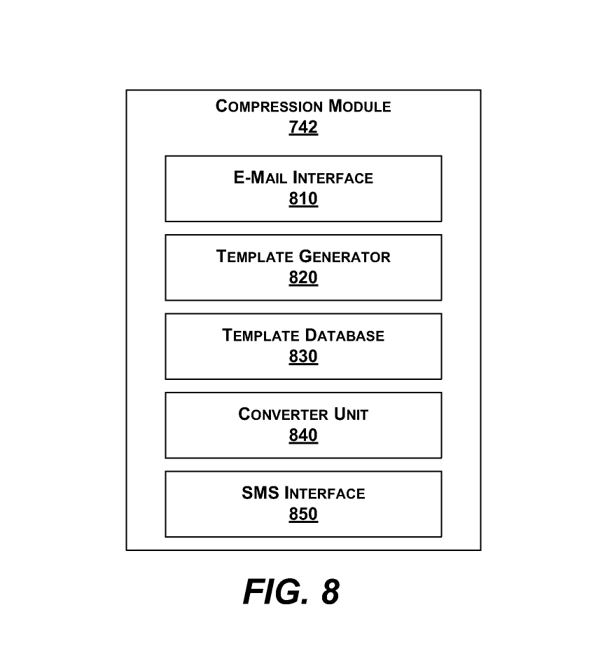

FIG. 8 is a block diagram of a compression module 742 of the e-mail server 520 according to an embodiment. The compression module 742 includes an e-mail interface 810, a template generator 820, a template database 830, a converter unit 540 and an SMS interface 850. The components can communicate with each other through, for example, APIs (Application Programming Interfaces). In other embodiments, all or parts of the components can be implemented in hardware or benefit from special hardware accelerators.

In one embodiment, the e-mail interface 810 receives e-mail messages from an e-mail application. The template generator 820 allows custom templates to be created by a user. The template database 830 stores default and custom templates. The converter unit 840 applies a template to an e-mail to produce an SMS message. The SMS interface 850 sends a compressed e-mail message as an SMS message to SMS gateway 530 of FIG. 5.

As described herein, computer software products may be written in any of various suitable programming languages, such as C, C++, C#, Pascal, Fortran, Perl, Matlab (from MathWorks), SAS, SPSS, JavaScript, AJAX, and Java. The computer software product may be an independent application with data input and data display modules. Alternatively, the computer software products may be classes that may be instantiated as distributed objects. The computer software products may also be component software such as Java Beans (from Sun Microsystems) or Enterprise Java Beans (EJB from Sun Microsystems). Many of the functionalities described herein can be implemented in computer software, computer hardware, or a combination.

Furthermore, the computer that is running the previously mentioned computer software may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A computer-implemented method for forwarding e-mail messages, comprising:
receiving an e-mail message addressed to a recipient and comprising header data and message content;
applying a template to transform the e-mail message to an SMS (Short Message Service) format; and
forwarding the message to the recipient as a first SMS message.

2. The method of claim 1, wherein applying the rule-based template comprises:
removing the header data.

3. The method of claim 1, wherein applying the rule-based template comprises:
abbreviating the message content by removing non-unique portions.

4. The method of claim 1, further comprising:
classifying the e-mail message; and
applying a rule-based template corresponding to the classification, the rule-based template being preconfigured to identify essential information in the e-mail message.

5. The method of claim 1, further comprising:
forwarding a second SMS message responsive to receiving a request, the second SMS message comprising additional message content relative to the first SMS message.

6. The method of claim 1, further comprising:
prior to receiving the e-mail message, providing a template editor to the receiver;
receiving anchor points from the receiver, the anchor points identifying essential information in the e-mail message; and
converting the anchor points to the rule-based template.

7. The method of claim 1, further comprising:
prior to receiving the e-mail message, associating the rule-based template with a specific type of e-mail; and
identifying the e-mail message as matching the specific type of e-mail.

8. The method of claim 1, wherein associating the rule-based template comprises:
associating the rule-based template with specific a type of e-mail selected from one of: a sender, a date, a subject matter, a priority level, and a keyword.

9. A computer program product stored on a non-transitory computer-readable medium that when executed by a processor, performs a method for forwarding e-mail messages, comprising:
receiving an e-mail message addressed to a recipient and comprising header data and message content;
applying a template to transform the e-mail message to an SMS (Short Message Service) format; and
forwarding the message to the recipient as a first SMS message.

10. The computer program product of claim 9, wherein applying the rule-based template comprises:
removing the header data.

11. The computer program product of claim 9, wherein applying the rule-based template comprises:
abbreviating the message content by removing non-unique portions.

12. The computer program product of claim 9, further comprising:
classifying the e-mail message; and
applying a rule-based template corresponding to the classification, the rule-based template being preconfigured to identify essential information in the e-mail message.

13. The computer program product of claim 9, further comprising:
forwarding a second SMS message responsive to receiving a request, the second SMS message comprising additional message content relative to the first SMS message.

14. The computer program product of claim 9, further comprising:
prior to receiving the e-mail message, providing a template editor to the receiver;
receiving anchor points from the receiver, the anchor points identifying essential information in the e-mail message; and
converting the anchor points to the rule-based template.

15. The computer program product of claim 9, further comprising:
prior to receiving the e-mail message, associating the rule-based template with a specific type of e-mail; and
identifying the e-mail message as matching the specific type of e-mail.

16. The computer program product of claim 9, wherein associating the rule-based template comprises:
associating the rule-based template with a specific type of e-mail selected from one of: a sender, a date, a subject matter, a priority level, and a keyword.

17. A system to forward e-mail messages, comprising:
an interface to receive an e-mail message addressed to a receiver and comprising header data and message content; and
a converter unit, communicatively coupled to the interface, to apply a template to transform the e-mail message to an SMS (Short Message Service) format,
wherein the interface forwards the message to the receiver as a first SMS message.

18. The system of claim 17, wherein the converter unit classifies the e-mail message, and applies a rule-based template corresponding to the classification, the rule-based template being preconfigured to identify essential information in the e-mail message.

19. The system of claim 17, further comprising:
a template editor to, prior to receiving the e-mail message, receive anchor points from a user, the anchor points identifying essential information in the e-mail message, converting the anchor points to the rule-based template.

20. The system of claim 17, wherein the converter unit prior to receiving the e-mail message, associates the rule-based template with a specific type of e-mail, and identifies the e-mail message as matching the specific type of e-mail.
